(19) United States
(12) Patent Application Publication
(10) Pub. No.: US 2010/0131357 A1
(43) Pub. Date: May 27, 2010

(54) System and method for controlling user and content interactions

(76) Inventors: Ryan Steelberg, Irvine, CA (US); Chad Steelberg, Newport Beach, CA (US)

Correspondence Address: DRINKER BIDDLE & REATH;ATTN: INTELLECTUAL PROPERTY GROUP, ONE LOGAN SQUARE, SUITE 2000, PHILADELPHIA, PA, 19103-6996, US

(21) Appl. No.: 12/590,669

(22) Filed: Nov. 12, 2009

Related U.S. Application Data
(63) Continuation-in-part of application No. 12/144,194, filed on Jun. 23, 2008.
Application No. 12/144,194 is a continuation-in-part of application No. 11/981,646, filed on Oct. 31, 2007.
Application No. 11/981,646 is a continuation-in-part of application No. 11/981,837, filed on Oct. 31, 2007.
Application No. 11/981,837 is a continuation-in-part of application No. 12/072,692, filed on Feb. 27, 2008.
Application No. 12/072,692 is a continuation-in-part of application No. 12/079,769, filed on Mar. 27, 2008.
Application No. 12/079,769 is a continuation-in-part of application No. 12/042,913, filed on Mar. 5, 2008.
Application No. 12/042,913 is a continuation-in-part of application No. 12/072,692, filed on Feb. 27, 2008.
Application No. 12/072,692 is a continuation-in-part of application No. 11/981,646, filed on Oct. 31, 2007.
(60) Provisional application No. 61/114,688, filed on Nov. 14, 2008.
(60) Provisional application No. 60/993,096, filed on Sep. 7, 2007.

(51) Int. Cl. G06Q 30/00; G06Q 10/00; G06F 3/048; G06F 15/16; H04L 9/32

(52) U.S. Cl. 705/14.45; 705/14.54; 705/14.72; 715/742; 715/741

(57) ABSTRACT

An asset management engine, system and method. The engine, system and method may include a vault including at least one asset, an administration display including a plurality of DLLs for controlling interrelations of the at least one asset to at least one field, and an asset classification module including at least one table, wherein the at least one table includes a plurality of simultaneously viewable ones of the at least one fields, wherein at least two of the fields include a unique category of ones of the at least one asset, and wherein ones of the unique category are accessible only to select users indicated via said administration display. A campaign delivery service that delivers campaigns created by ones of the select users and integrating ones of the at least one asset from ones of the category that are accessible to the creating ones of the select users may also be included.

### CROSS-REFERENCE TO RELATED APPLICATIONS

The present application claims priority to U.S. Provisional Application No. 61/114,688 entitled “System and Method For Controlling User and Content Interactions,” filed Nov. 14, 2008, and is a continuation-in-part of U.S. patent application Ser. No. 12/144,194, entitled “System and Method For Brand Affinity Content Distribution and Optimization”, filed Jun. 23, 2008, the entire disclosures of which are incorporated by reference herein as if set forth in their entirety.

U.S. patent application Ser. No. 12/144,194 is: a continuation-in-part of U.S. patent application Ser. No. 11/981,646, entitled “Engine, System and Method for Generation of Brand Affinity Content”, filed Oct. 31, 2007; a continuation-in-part of U.S. patent application Ser. No. 11/981,837, entitled “An Advertising Request And Rules-Based Content Provision Engine, System and Method”, filed Oct. 31, 2007; a continuation-in-part of U.S. patent application Ser. No. 12/072,692, entitled “Engine, System and Method For Generation of Brand Affinity Content, filed Feb. 27, 2008; and a continuation in part of U.S. patent application Ser. No. 12/079,769, entitled “Engine, System and Method for Generation of Brand Affinity Content,” filed Mar. 27, 2008.

U.S. patent application Ser. No. 11/981,837 claims priority to U.S. Provisional Application Ser. No. 60/993,096, entitled “System and Method for Rule-Based Generation of Brand Affinity Content,” filed Sep. 7, 2007, and is related to U.S. patent application Ser. No. 11/981,646.

U.S. patent application Ser. No. 12/079,769 is a continuation-in-part of U.S. patent application Ser. No. 12/042,913, entitled “Engine, System and Method for Generation of Brand Affinity Content,” filed Mar. 5, 2008, which is also a continuation-in-part of U.S. patent application Ser. No. 12/072,692.

U.S. patent application Ser. No. 12/072,692 is a continuation-in-part of U.S. patent application Ser. No. 11/981,646.

The disclosures of which are incorporated by reference herein as if each is set forth in its entirety.

### FIELD OF THE INVENTION

The present invention is directed to an access and asset management system and, more particularly, to a role assignments system with interrelations of allowed operations on assets to users and groups of users, and a method of making and using same.

### BACKGROUND OF THE INVENTION

High impact advertising is that advertising that best grabs the attention of a target consumer. A target consumer is the ideal customer for the particular goods being advertised, from a socio-economic perspective, from a morals and values perspective, from an age or interest level perspective, or based on other similar factors. The impact on an ideal customer of any particular advertisement may be improved if an advertisement includes endorsements, sponsorships, or affiliations from those persons, entities, or the like from whom the ideal target consumer is most likely, or highly likely, to seek guidance. Further improvement in advertising impact may be experienced wherein advertising campaigns are managed by those most knowledgeable about certain products, consumers, brands, or the like. For example, premier campaign managers will understand best those factors that will increase the impact of an endorser, including the endorser's perceived knowledge of particular goods or in a particular industry, the fame or popularity of the endorser, the respect typically accorded a particular endorser or sponsor, and other similar factors.

However, the available art provides no automated mechanism of providing advertising campaign management by those best suited to manage such campaigns. Further, the available art provides little capability to manage roles within groups, particularly in the advertising industry.

Thus, there exists a need for an engine, system and method that allows for the management of access and assets particularly in the aforementioned high-impact circumstances, for a specific individual, a specific entity, a brand, a marketing partner, or a sponsor, for example.

### SUMMARY OF THE INVENTION

The present invention includes at least an advertising engine, system and method, which includes at least one vault having media assets, a recommendation engine that matches the media assets from the vault with at least one requested creative, and a delivery engine that integrates the requested creative with the matched media assets from the vault further utilizing an administration function module and a dissemination logistics module.

The present invention further provides an access and asset management system, and a role assignments system with interrelations of allowed operations on assets to users and groups of those users, and a method of making and using same. The assets managed may include those vault assets, and/or those assets matched by the recommendation engine.

The present invention may further include an asset management engine, system and method. The engine, system and method may include a vault including at least one asset, an administration display including a plurality of DLLs for controlling interrelations of the at least one asset to at least one field, and an asset classification module including at least one table, wherein the at least one table includes a plurality of simultaneously viewable ones of the at least one fields, wherein at least two of the fields include a unique category of ones of the at least one asset, and wherein ones of the unique category are accessible only to select users indicated via said administration display. A campaign delivery service that delivers campaigns created by ones of the select users and integrating ones of the at least one asset from ones of the category that are accessible to the creating ones of the select users may also be included.

Thus, the present invention provides an engine, system and method that allows for the management of access and assets particularly in the aforementioned high-impact circumstances, for a specific individual, a specific entity, a brand, a marketing partner, or a sponsor, for example.

### BRIEF DESCRIPTION OF THE FIGURES

The present invention will be described hereinbelow in conjunction with the following figures, in which like numerals represent like items, and wherein:

FIG. 1 illustrates an exemplary embodiment of the present invention;

FIG. 2 illustrates an exemplary embodiment of the present invention;

FIG. 3 illustrates an exemplary embodiment of the present invention; and

FIG. 4 illustrates an exemplary embodiment of the present invention;

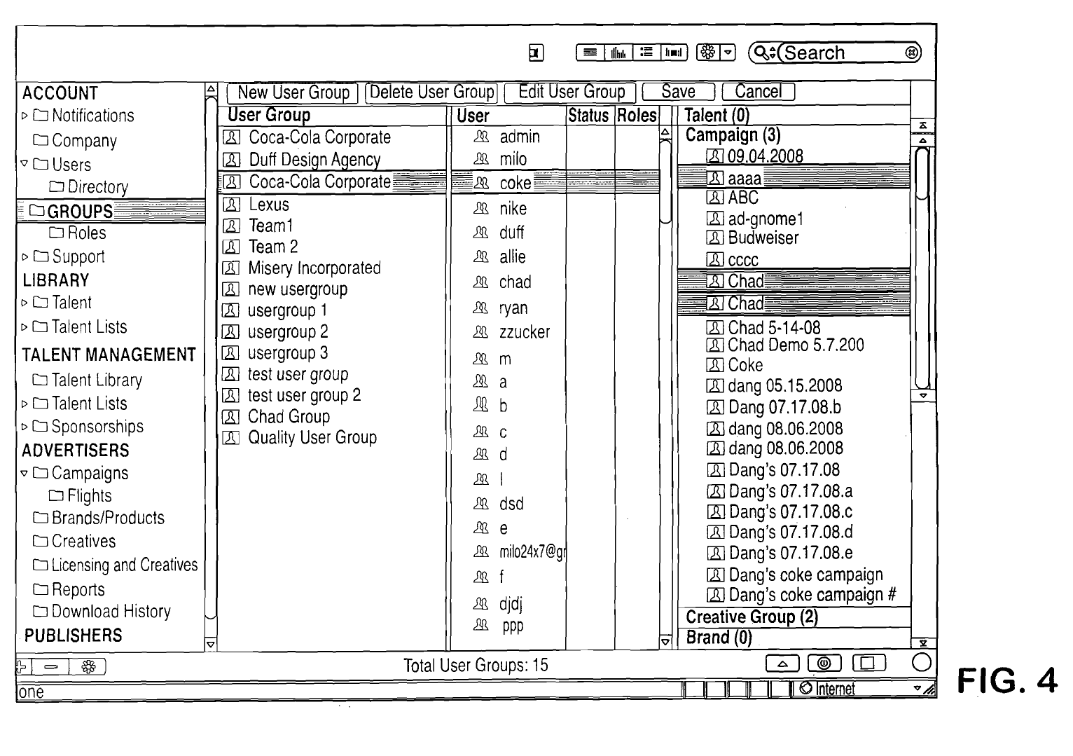

### DETAILED DESCRIPTION OF THE INVENTION

In the description that follows, the invention is described with reference to acts and symbolic representations of operations that are performed by one or more computers, unless indicated otherwise. As such, it will be understood that such acts and operations, which are at times referred to as being computer-executed, include the manipulation by the processing unit of the computer of electrical signals representing data in a structured form. This manipulation transforms the data or maintains them at locations in the memory system of the computer, which reconfigures or otherwise alters the operation of the computer in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that several of the acts and operations described hereinafter may also be implemented in hardware.

Further, it is to be understood that the figures and descriptions of the present invention have been simplified to illustrate elements that are relevant for a clear understanding of the present invention, while eliminating, for purposes of clarity, many other elements found in a typical computerized engine, system and method. Those of ordinary skill in the art will recognize that other elements are desirable and/or required in order to implement the present invention. However, because such elements are well known in the art, and because they do not facilitate a better understanding of the present invention, a discussion of such elements is not provided herein. The disclosure herein below is directed to all such variations and modifications to planning technologies known, and as will be apparent, to those skilled in the art.

It is generally accepted that advertising (hereinafter also referred to as “ad” or “creative”) having the highest impact on the desired consumer base includes well managed campaigns of advertising, including those campaigns reliant on endorsements, sponsorships, or affiliations from those persons, entities, or the like from whom the targeted consumers seek guidance, such as based on the endorser's knowledge of particular goods or in a particular industry, the fame of the endorser, the respect typically accorded a particular endorser or sponsor, and other similar factors. Additionally, the easiest manner in which to sell advertising time or blocks of advertising time is to relay to a particular advertiser that the advertising time purchased by that advertiser will provide optimal impact on the desired target audience, which may entail inclusion of an endorsement therein for that particular advertiser's brand of goods or services. As used herein, such an endorsement may include an assertion of use of a particular good or service by an actor, actress, or subject in the audio visual work, reference to a need for a particular types of goods or services in the audio visual work, or an actual endorsement of the use of a product within the audio visual work.

Endorsements and ad campaigns with or without endorsements may be limited in certain ways, as will be apparent to those skilled in the art. Such limitations may include geographic limitations on the use of particular products (endorsers are more likely to endorse locally in various locales rather than nationally endorse, in part because national endorsements bring a single endorsement fee and generally preclude the repetitious collection of many smaller fees for many local endorsements), or limitations on use in particular industries, wherein a different product or a different industry may be advertised or endorsed (such as in a different geographical area) by the same endorser or a competitive advertiser, or limitations on endorsements solely to a particular field(s) or type(s) of product, rather than to a specific brand of product. Further, endorsements by particular endorsers may be limited to products, brands or products or services, types of products or services, or the like which are approved by one or more entities external from, but affiliated with, the specific endorser. For example, the National Football League may allow for its players only to endorse certain products, brands of products, types of products, or the like, that are also endorsed by the NFL.

More specifically, as used herein endorsements may include: endorsements or sponsorships, in which an individual or a brand may be used to market another product or service to improve the marketability of that other product or service; marketing partnerships, in which short term relationships between different products or services are employed to improve the marketing of each respective product or service; and brand affinity, which is built around a long term relationship between different products or services such that, over time, consumers come to accept an affinity of one brand based on its typical placement with another brand in another industry.

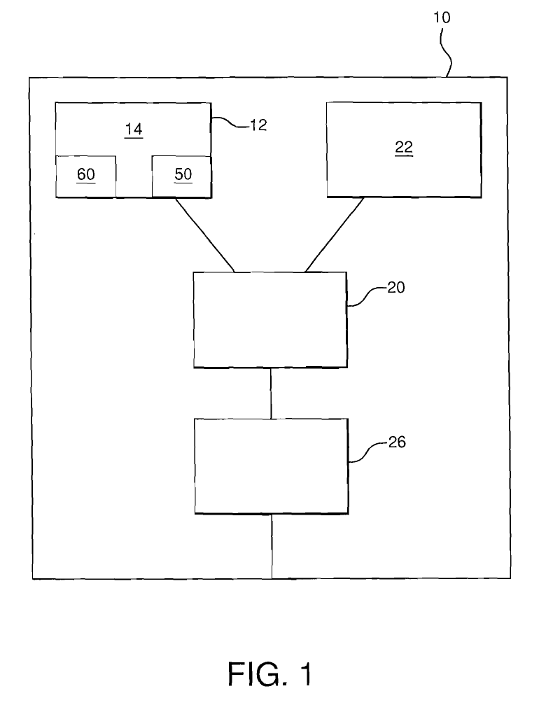

At present, there is a need for a platform or engine to allow for the obtaining of an ad, an endorsement, or endorsed ad, in any of the above circumstances, either from a specific individual, a specific entity, an affinity brand, a marketing partner, or a sponsor. In the present invention, an advertising engine 10, such as that illustrated in FIG. 1, may include a vault 12 that provides media assets 14 and integration of media assets without need of involving the media assets for permission, a brand association or recommendation engine 20 that may, by creative, by market, by brand affinity, by user request, or otherwise match media assets from the vault with a creative/ad 22, and a delivery engine 26 capable of integrating a requested ad 22 with the media asset 14 from the vault 12, late stage binding of the at least partial creative 22 and media asset 14 upon delivery to strongest target consumers, and/or delivery of the ad 22 and the dynamic media asset 14 from the vault to an advertiser or advertising server, which then places the mash up of the ad and media asset. Ad requests 22 may be made via an “ad wizard” using ad templates, as will be apparent to those skilled in the art.

The vault captures certain brands and information related thereto in a common database, such as all major league baseball, past and present players, including statistics, video, and pictures of those players affiliated with the names of those players, in addition to any endorsement limitations on those players. The vault may include media assets that may be associated with audio-visual works. The vault may include symbols, emblems, taglines, pictures, video, press releases, publications, web links, web links to external content, and media capable of re-purposing (such as an athlete running in front of a blue screen, wherein the athlete may be re-purposed by the placement of a background over the blue screen), including pictures, voice, and video. The vault may also include, associated with the brand, exclusion, inclusions, or preferences 50 for the use of the brand or particular items of information associated with the brand in the vault. Such inclusions, exclusions, or preferences may include geographic limitations on certain information items or endorsements, product limitations, preferred partners or products or product types for endorsement, etc. Exclusions may, of course, be necessary if the requested endorsement conflicts with a pre-existing endorsement agreement for the requested brand with a competitor, or the like.

Further, media assets in the vault may be marked with different payment schema 52 based on the requester of the media asset. For example, in the event the ad requester is a school, and the requested creative is not an ad to sell anything, media assets may be available for use for free. Such exceptions may be made, with regard to payment, with regard to any level of payment variation as between any number of different user types, such as non-profit, for-profit, individual, corporate, in-home, in-business, and the like. Additionally, for example, icons of a favorite football player may be requested by a non-profit individual for at-home use, to be overlayed over a live football program then on that individual's television, at no charge to that individual.

The brand association and recommendation engine 20 assesses, based on numerous factors including external factors, the endorsements that are most sensible for particular advertising. For example, such a brand association engine gauges proper matches by assessing inclusions and exclusions based on the aforementioned factors in the vault, such as geography, but additionally can use stored or external information and/or variable factoring to do brand associations for any two brands (such as wherein brand associations already exhibiting brand affinity would have the highest percentage association, and brands which would make the most sensible association would also exhibit higher percentage matching for brand association), or to do matching with an endorsement brand based on the target consumers of the requesting brand.

For example, a “profile” 60 may be developed in the vault for a particular brand. Such a profile may include any of a myriad of information, both stored in the vault and having external references outside the vault from within the vault, including but not limited to psychological profiles of typical users of that brand (which may include values, motivations, wants, and needs of such users, and which may be assessed based on inferences from on-line, credit card, or television use by those users, for example), brand profiles including target customers, target affiliate profiles (which may include reasons for desired affiliation, such as sharing marketing costs, increasing brand recognition in certain geographies or fields of use, distribution channel access, expedited market entry, or improved brand perception, for example), and the like, and such profiles may be used as media assets by the recognition, engine in order to develop a best match. As an additional example, polling may provide for local or national focus and maintained in the vault as an associated media asset with a particular brand, and best matches for certain brands may be selected according to such polling results. For example, a “flashy” sports personality may be a best match for a brand offering in Los Angeles, but a different athlete's endorsement might be preferably to sell that brand in the mid-west. Such information, including “who's hot”, or where a brand is “hot”, may be associated with the media assets regarding that brand in the vault, and may be thus used by the recommendation engine to do matching.

Thus, the recommendation engine may passively or actively inform of the best endorsement matches for a particular user's ads, based on any number of factors. Upon assessment of good matches for the requesting brand, a user of the present invention may have the matching options presented to that user for selection by the recommendation engine, or the user may simply have a best-match selection made for the user. Needless to say, bids for advertising may vary based on the matches obtained by the recommendation engine, and/or the asserted likelihood of success that the ad placed will be successful. Success, of course, may be different in different circumstances, and may include a consumer making an on-line or in-store purchase, a user filling out an on-line or off-line form, a consumer accessing and downloading information or a coupon, or the like.

The delivery engine 26 may integrate a requested ad with the media asset from the vault pursuant to the actions by the recommendation engine, and can place a particular ad in the environment it deems best suited for that ad (such as in the event of a re-direct, wherein a web site gives some information about an ad request, and the best ad can be placed responsive to the ad request), late stage bind the ad and media asset for delivery to strongest target consumers (such as with the improvement in later stage tracking for improved ad targeting, such as if the consumer's requesting IP address and/or the referring site information is available just prior to ad delivery), or deliver the static ad and the dynamic media asset from the vault to an advertiser or advertising server, which then independently places the mash up of the ad and media asset. Needless to say, bids for advertising time may vary depending upon the delivery mechanism used.

Improvement in later stage tracking for improved ad targeting may be enabled through the delivery engine 26 and will allow for greater efficiency the trafficking of ads during or after or with or without interface with the delivery engine 26. Efficiency may be obtained by tracking, for example, the data intelligence for use with the delivery of the creative. By way of non-limiting example, data intelligence may include click-thru rate, post-click conversion rate, post-impression activities, as well as geography, demographic and day part information. Gathered data intelligence may be used as individual properties in conjunction with each other to form or produce the level of intelligence needed to achieve the desired efficiencies. By way of further example, data intelligence may also include information regarding the number of impressions an ad has received, the elapsed time between an impression or a click.

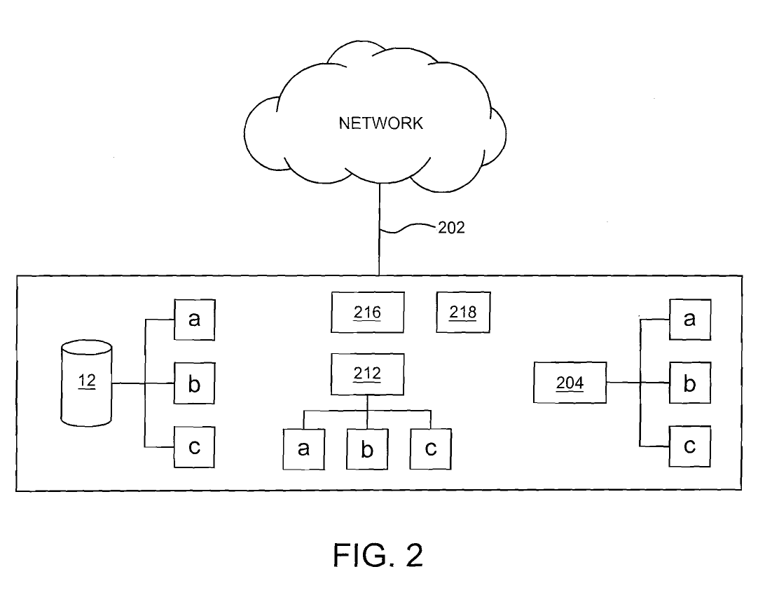

To efficiently access and use certain aspects of the present invention, an access and asset management system in accordance with the present invention is shown in FIG. 2. The management system may be utilized, for example, for collecting, storing, and disseminating information and ideas, such as, for example, at least one asset. Users may search, view, and organize information related to the at least one asset. Administrators may interact with the user management system to add information, provide interactive guidance on asset selection, and/or control the flow of information, for example. Administrators may additionally control the use and content of the user management system. The user ‘management system may include network access 202 to administration function modules 204, at least one database, such as from the vault 12, for example, and dissemination logistics module 212. The user management system may also include a search functionality module 216, for example.

The administration function module 204 may include administrative controls, information entry and management, and security and access control 204a-c. The vault 12 may include a display function module, attribute association module, and information refinement 12a-c. The dissemination logistics module 212 may include network portal, report compiler and editor highlights 212a-c. The dissemination logistics module 212 may further have the ability to manipulate and identify select data attributes and any associated information. These functions may be supported by search functionality module 216 and report mechanism module 218.

The management system of FIG. 2 may include this multiplicity of integrated components and at least one logical and/or relational database, which may be relational to, or part of, the vault 12. Information, such as assets, in the user management system may necessitate or include one or more of the functions or modules of FIG. 2, depending on the requirements of the user. Furthermore, for each piece of information, there may be a set of data attributes that may be tracked and that may be unique to the management system. Some of the data attributes for each piece may be required, and others may be used at the administrator's discretion.

The user management system may utilize, for example, dynamic link libraries (DLL) that link the information data, such as the administrator's choice of component and fields, and HTML, xml, or ASPX templates, for example. These DLLs may process the HTML templates before presentation to a user of the interface, replacing tags and information in the HTML template with the defining attributes captured. Thereby, the administrator may have control of the layout and presentation of the data, and the management system may thus ensure that capture validation and storage of data is consistent across all information.

The vault 12 may include display function module, attribute association module, such as an associator, for example, and information refinement, for example. The display function module may control the fields shown to the user, and may include the ability to hide or reveal attributes and respond to user access privilege logic, for example. Further, one or more attributes may be associated to information in the user management system. An attribute may include metrics such as demography, hits, time of day, successful click through, etc, for example. One or more information pieces may be refined by attribute. Refinement may include, for example, sorting and/or filtering.

The reporting may report real-time status of user activities, for example, a tabular format including site usage by functionality, hits to the management system, user browser environment, and individual user usage. Reporting may be a real time, Internet-based format for secure access from any computer having access to the network, such as the internet or an intranet, on which the user management system is resident.

Security access control may authenticate a user. Users of the system may log into the system via an internet portal and access the system through the protections of a user name and password, for example. In addition, the security module may provide access control once the user has been authenticated. Multiple levels of access control may be defined. For example, one level may be for system administrators and another may be for a client user. System administrators may have full access to the application to add, delete and update the data, and client users may have limited access.

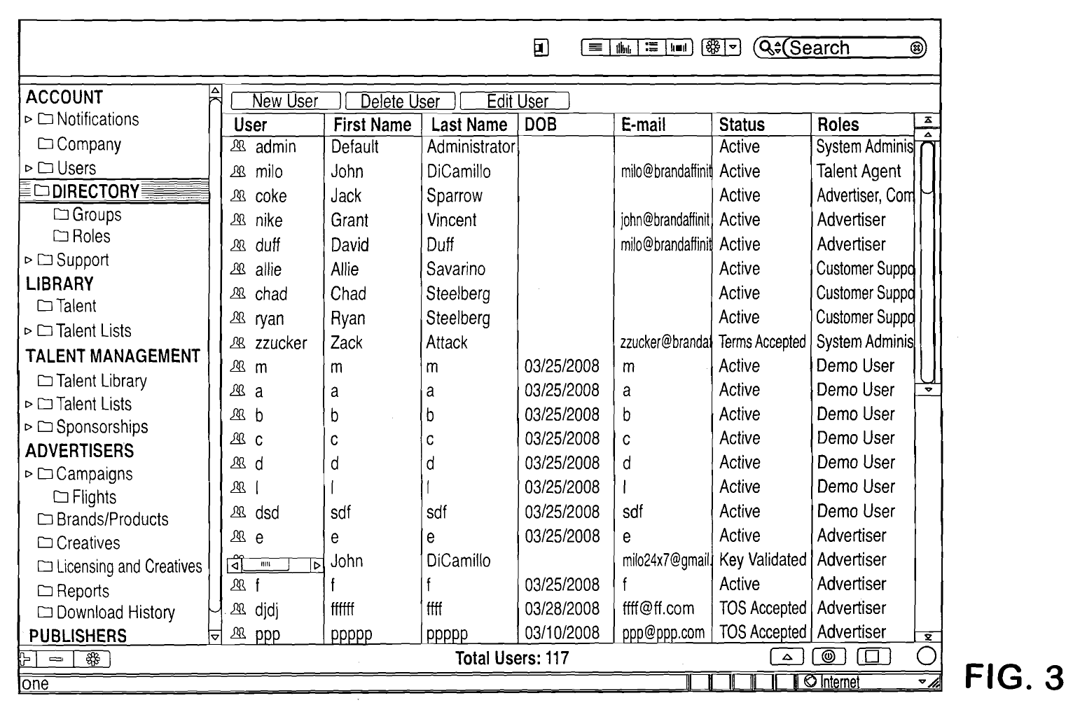

Administrators may also control aspects of each user of the system from an individual level to a more macro, or group level. By way of further example, as illustrated in FIG. 3, individual user information may be changed through editing, added anew, or deleted from the system. Although any amount of information may be collected and/or displayed by the system, the administrator, may, for example, choose to display the user's id, first and last name, date of birth, contact information, system status and/or assignments or permissions within the system.

The management system allows for user access to documents and information, such as assets, in at least one defined group. Further, each at least one defined group may have access to certain information further delineated between at least one user assigned to the at least one group. A user group may be defined by the system administrator and may contain at least one authorized user of the system. Within the defined user group may be information associated to the group. Although the same information may be shared by more than one user, the associated information may generally be associated with just one user group. Similarly, the information associated with the user group may be associated to at least one of the users assigned to the user group.

By way of non-limiting example only, a user group may be created which identifies a client of the user, such as, for example, Bob's Boat Sales (“BBS”). The created group may then have associated with it one or more users of the system who work with or need access to the information associated with BBS. The user group and user may, in concert, have associated therewith a further set of subject matter “buckets”, including, talent or assets, campaigns, creative groups and/or brands, for example. The bucket groups may include the content and features meant to be associated and used by the user of the system with the subject of the user group. Thus, BBS may have Chad and Duff as users, who in turn have access or ownership over certain campaigns that may be useful with or developed for BBS and/or with certain talents that may be associated with BBS.

In the same way that certain buckets are associated with certain users and user group combinations, different combinations of user group and users may yield various associations of buckets. For example, Chad and Duff may have access to a smaller set of buckets together than apart, even though the client remains BBS. Similarly, clicking on various objects within each bucket may illustrate the users and user groups associated with that object. In other words, the visual layout and associations between groups, users and assets/content, allows each user of the system to visualize the interrelations between the associated items.

As discussed herein, the ability of the system administrator extends to control over the information accessible to each user and user group. These permissions by the system administrators may allow for not just selective access to certain objects and information, but also degrees of access, both to the system and to the information therein. For example, the system administrator may allow Chad to edit and save to the system a new version of a campaign for the BBS user group, while Duff may be limited to just reviewing anything created by Chad.

Users may also be associated with buckets and/or objects/assets/content based on the classification of the same. For example, Chad may have permissions to view all objects related to beverages. This correlation may supersede group based assignments. Similarly, such a permission may only be active if, in addition to user permissions, the group allows for such permissions to be active. For example, although a Budweiser group may allow all beverage objects associated with Chad to be viewed, a restriction may be in place, in this case, on an object associated with both Chad and Miller Brewing. Thus, although “beverage” associations are accessible, certain competitive objects may be filtered out.

The association of keywords with the multiple document/object/asset types contained within the management system allows a user to properly categorize a particular object, and allows the user to categorize the object as it is entered into the management system, or as it is created using the management system, or as it is within view of the management system. Thereby, the present invention provides a highly accurate classification within the management system, which may be based on the familiarity of the with the subject matter.

A user who chooses to associate a keyword to a new object may be taken to the keyword association list window. The keyword association window may provide access to all objects contained within the user management system. The window may display the keyword chosen associated with one or more objects within the management system, and/or a table containing a listing of the objects/assets contained within the user management system. The objects may be listed in any order, including alphabetically by keywords or associated keyword, author, title and file type, for example. Each listed object may also contain an option box allowing the user to click whether or not that object should be associated with the presently selected keyword. Once one or more objects have been selected to be associated with the keyword, unselected objects may be removed from being associated with the keyword. This function may update the management system with the association of the keyword with the objects selected.

As discussed above, the present management system may provide for administrative control over the contents of, and access to, the user management system. Additionally, a user may be an administrator and may be responsible for adding, removing and maintaining documents or content within the user management system. Additionally, an administrator may control user access and other contents of the management system. Thus, the user management system may provide an administration log-in window. This window may allow authorized personnel to enter a valid user name and password which may allow access to the management system. Successful log-in may lead the user to the management system administration main window. This main window may include links allowing the user to navigate to the home main menu, to the links page, the editors choice administration page, the reports window and the user maintenance window, for example. The main window may also provide a listing of objects contained in the user management system. The user may further have the ability to add objects to the user management system, remove existing objects from the user management system, or access existing documents for the purposes of editing, such as to assign or update association criteria, for example. By clicking the add new link button in the administration main window, the user may move to the administration add document window.

This window may allow the administrator to add new objects/documents/assets to the management system and/or associate therewith certain groups and/or users. The administrator may choose to designate characteristics, such as file type, document type, title, description and author, for example. The administrator may also add a file by completing, in the file field, the location of the document, or by selecting the document by clicking the browse button to search for the document by techniques known to those skilled in the art.

The delete document window may include a listing of all or a portion of the documents included in the management system. This list of documents may further be sorted by year, source, author, title and file type, for example. The list of documents in this window may also include an option box associated with each document. This option box may allow the user to choose and select documents desired to be deleted from the user management system. If one or more documents are selected by checking the option box associated with the particular document, those documents may be deleted from the user management system by clicking the delete button at the bottom, which may be of the delete document window.

Once a document is added to the user management system, such as in the exemplary manners discussed above, the administrator may specify unique document information to further refine user searches. An administrator may be encouraged to associate attributes and keywords, for example, and/or meetings, with each document to provide users with more complete research results.

As previously stated, once a document is added to the management system, an administrator may specify unique document information to further refine use searches and the association between uses and buckets, for example. The associated keywords portion, as provided in the document maintenance window for the document currently being added or edited by the administrator, may allow the administrator to add or modify the associated keywords by clicking the keyword maintenance button to provide access to the keyword administration window.

Further, keywords may be associated with the documents contained in the management system through the keyword administration window. The keyword administration window may be divided in two portions. The first portion may contain keywords already included within the user management system, while the second portion may provide functionality allowing the association of existing keywords with existing and newly created documents within the user management system. In the first portion, keywords already existing in the user management system, as entered by the administrator and as more thoroughly described above, may be organized in top level and lower level categories, each with sublevel access using the plus symbol icon as described above.

The management system may further provide an administrator with access to reporting/auditing functionality. Audit reports available to the administrator in the report list window may include, for example, summary statistics, user browser environment, referral report, individual user usage and document tracking, including object editing and copying, for example. These reports may also be accessed by clicking the hyperlink entitled the same. For example, by clicking the hyperlink entitled summary statistics, the administrator may access to the summary statistics report window. The summary statistics report window may include general statistics about the users and uses of the user management system. The summary statistics window may include a table entitled “general statistics” which may provide a count of the visitors or users of the user management system for the chosen day, the number of visitors for the chosen week, the number of visitors for the chosen month, the number of visitors for the given year, and the total visitors or users of the user management system since its inception, for example. The statistics report may also provide a table outlining uses. The site usage report may outline the percentage of users revisiting various sections of the user management system.

A graph incorporated in the statistics report may be, for example, an hourly breakdown graph. This graph may illustrate the usage of the user management system during a twenty-four hour period. By way of non-limiting example only, the hourly breakdown may show that during the time period from 3:00 am to 5:00 am the percentage of users using the management system is zero, while that same time period in the pm, twenty-three (23%) percent of users registered on the management system access and use the management system. The statistics report may further contain graphs illustrating the hit by month for the current year, and for previous years the management system has been in use. By way of non limiting example only, a table illustrating the hits by month of the current year may show that during the month of May, there were seventy-one hits compared to thirty-one hits in the same month for the previous year.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention as set forth in the claims hereinafter.

What is claimed is:

1. An asset management system, comprising:
a vault comprising at least one asset;
an administration display comprising a plurality of DLLs for controlling interrelations of the at least one asset to at least one field;
an asset classification module comprising at least one table, wherein the at least one table comprises a plurality of simultaneously viewable ones of the at least one fields, wherein at least two of the fields comprise a unique category of ones of the at least one asset, wherein ones of the unique category are accessible only to select users indicated via said administration display;
a campaign delivery service that delivers campaigns created by ones of the select users and integrating ones of the at least one asset from ones of the category that are accessible to the creating ones of the select users.

2. The asset management system of claim 1, wherein said administration display comprises access control for accessing said asset classification module.

3. The asset management system of claim 1, wherein said administration display comprises security control for the at least one asset.

4. The asset management system of claim 1, wherein said asset classification module comprises a network portal.

5. The asset management system of claim 1, wherein said administration display further comprises a search engine.

6. The asset management system of claim 1, wherein at least one of the at least one asset comprises a template to create an advertisement.

7. The asset management system of claim 6, wherein the template comprises at least one selected from the group consisting of an HTML, xml, and ASPX template.

8. The asset management system of claim 1, wherein the administration display comprises control of layout of the asset classification module.

9. The asset management system of claim 1, wherein the at least one asset comprises at least a media asset and at least one of demography, hits, time of day, and successful click of the media asset.

10. The asset management system of claim 1, wherein the administration display comprises a log-in.

11. The asset management system of claim 10, wherein different ones of the log-in comprise different access levels to ones of the categories in said asset classification module.

12. The asset management system of claim 1, wherein a first of the fields comprises one of the campaigns related to interrelated ones of the assets, and wherein a second of the fields comprises assets related to the campaign, and wherein a third of the fields comprises a plurality of keywords associated with the assets.

13. The asset management system of claim 12, wherein ones of the fields comprise a client related to the campaign.

14. The asset management system of claim 12, wherein the select users are indicated by a keyword.

15. The asset management system of claim 12, wherein the select users are indicated by a client.

16. The asset management system of claim 12, wherein the select users are indicated by a campaign.

17. The asset management system of claim 1, wherein said administration display comprises filters for ones of the select users.

18. The asset management system of claim 1, wherein one of the select users comprises an advertising campaign manager.

19. The asset management system of claim 1, wherein ones of the assets comprise endorsements.

20. The asset management system of claim 1, wherein the assets comprise multimedia assets.

21. The asset management system of claim 1, wherein the campaign delivery comprises delivery to an advertising server.

22. The asset management system of claim 1, wherein the campaign delivery comprises delivery to a consumer.

23. The asset management system of claim 1, wherein the select users comprise members of a plurality of user groups indicated by one of the fields.
